(19) United States
(12) Patent Application Publication
(10) Pub. No.: US 2003/0067090 A1
(43) Pub. Date: Apr. 10, 2003

(54) Method of manufacturing a roller rod

(76) Inventor: Chih-Huang Chou, Shuh-Lin (TW)

Correspondence Address: JACOBSON HOLMAN PLLC, 400 SEVENTH STREET N.W., SUITE 600, WASHINGTON, DC, 20004, US

(21) Appl. No.: 09/969,688

(22) Filed: Oct. 4, 2001

(51) Int. Cl. B29C 31/00

(52) U.S. Cl. 264/259

(57) ABSTRACT

A method of manufacturing a roller rod, mainly comprises a pair of symmetrical die cavities in half-tube shapes disposed between an upper and a lower dies, two half-round bearing holes are disposed at two ends thereof and one pouring channel is disposed on one lateral side of the half-tube die cavity of the upper die; a central shaft penetrates through a seamless tube mounted inside the upper and the lower dies; the rubber material is poured between the central shaft and the seamless tube so as to form a rubber roller on the central shaft; according to the said manufacturing method, a rubber roller with no joint line but smooth surface is formed outside the central shaft.

### BACKGROUND OF THE INVENTION

1. Field of the Invention

A method of manufacturing a roller rod, more specifically, a method of manufacturing a rubber roller to be molded on a central shaft with no joint line; the said rubber roller has smooth surface without joint line.

2. Description of the Prior Art

Accordingly, the rolling shaft of the general printer or office machine for rolling paper to the copying machine or the printer has a rubber roller (b) formed on a metal made central shaft (a); the conventional method of manufacturing a rubber roller (b) on a central shaft (a), as shown in FIG. 7, comprises a pair of symmetric half-tube die cavities (c1, d1) disposed respectively on the upper die (c) and the lower die (d); two half-round bearing holes (c2, d2) are disposed respectively at two ends of the half-tube die cavities (c1, d1); the top plane of the upper die (c) is disposed with a material trough (c3); a pressing board (e) is housed in the upper aspect of the said material trough (c3) for pressing the rubber material out; the said pressing board (e) is mounted in the lower aspect of a pressing machine (not shown in the Figure); a pouring channel (c4) is disposed between the lateral sides of the material trough (c3) and the half-tube die cavity (c1); two ends of the central shaft (a) are bridged on the half-round bearing holes (c2, d2) of the upper die (c) and the lower die (d); the pressing board (e) presses the rubber material inside the material trough (c3) of the upper die (c) into the half-round die cavity (c1) of the upper die (c) so as to form a rubber roller (b) on the central shaft (a); then the product is taken out after the dies are opened, as shown in FIG. 8.

Since there is a jointed die plane between the half-tube die cavities (c1, d1) of the upper die (c) and the lower die (d), two joint lines (b1) are formed on the surface of the said rubber roller (b) after the said rubber roller (b) is molded, as shown in FIG. 9; therefore, the said rubber roller (b) requires more grinding on the surface thereof for obtaining a preferred real roundness; since the said rubber roller (b) molded on the central shaft (a) needs to be grinded and processed again, the manufacturing is troublesome as well as inconvenient and increases the manufacturing cost.

Furthermore, since the said rubber roller (b) requires more cutting and grinding, the outer diameter of the said rubber roller (b) must have predetermined processing allowance and the waste generated after the grinding and the processing increase the material cost.

In addition, the positions of the jointed lined (b1) of the said rubber roller (b) tends to cause the situation of hardening and stress concentration, therefore, the positions of the jointed lines causes shrinking condition later, thereby looses the real roundness and reduces the quality of the product.

The inventor of the present invention, addressed the mentioned shortcomings of the conventional roller rod and started to compose, finally designed a method of manufacturing a roller rod, mainly comprising a pair of symmetrical die cavities in half-tube shapes disposed between an upper and a lower dies, two half-round bearing holes disposed at the two ends thereof and one pouring channel is disposed on one lateral side of the half-tube die cavity of the upper die; a central shaft penetrates through a seamless tube mounted inside the upper and the lower dies; the rubber material is poured between the central shaft and the seamless tube so as to form a rubber roller on the central shaft; according to the said manufacturing method, a rubber roller with no joint line but smooth surface is molded outside the central shaft.

### SUMMARY OF THE INVENTION

Therefore, the primary objective of the present invention is to provide a method of manufacturing a roller rod to be molded on a central shaft with no joint line; the said rubber roller has smooth surface without joint line and preferred manufacturing quality.

To enable a further understanding of the present invention, the brief description of the drawings below is followed by the detailed description of the preferred embodiment.

### BRIEF DESCRIPTION OF THE DRAWINGS

FIG. 1 is a cross-sectional view drawing of an upper die and a lower die of the present invention.

FIG. 2 is a cross-sectional view drawing of the present invention with a central shaft and a seamless tube housed inside the upper and the lower dies.

FIG. 3 is a cross-sectional view drawing of the present invention with a rubber roller molded on a central shaft.

FIG. 4 is a pictorial drawing of the present invention being taken out with a seamless tube after the dies are opened.

FIG. 5 is a pictorial drawing of the present invention after a seamless tube is taken off.

FIG. 6 is a pictorial drawing of a product of the present invention.

FIG. 7 is a cross-sectional drawing of a conventional manufacture.

FIG. 8 is a drawing of a conventional product.

Figure is a cross-sectional drawing of a conventional product.

### DETAILED DESCRIPTION OF THE PREFERRED EMBODIMENTS

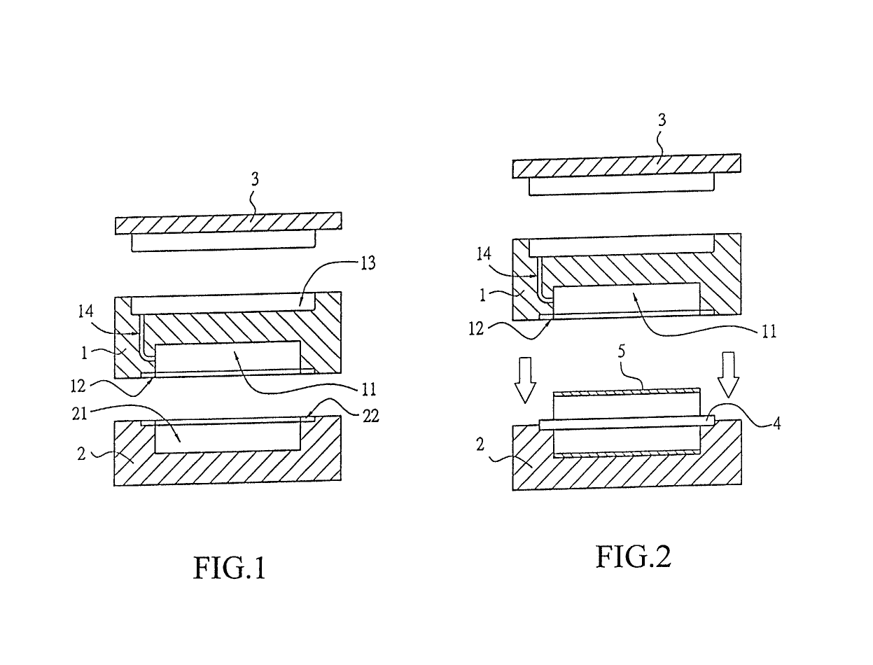

Referring to FIGS. 1 to 3, the present invention mainly comprises the following manufacturing stages:

(a) a pair of symmetric half-tube die cavities (11, 21) are disposed respectively between the upper die (1) and the lower die (2); two half-round bearing holes (12, 22) are disposed respectively at two ends of the half-tube die cavities (11, 21); the top plane of the upper die (1) is disposed with a material trough (13); a pressing board (3) is housed in the upper aspect of the said material trough (13) for pressing the rubber material out; the said pressing board (3) is mounted in the lower aspect of a pressing machine (not shown in the Figure); a pouring channel (14) is disposed between the lateral sides of the material trough (13) and the half-tube die cavity (11), as shown in FIG. 1;

(b) a central shaft (4) penetrates a seamless tube (5) and bridges on two opposite half-round bearing holes (12, 22) of the upper die (1) and the lower die (2) to make the seamless tube (5) house in the half-tube die cavities (11, 21) and coaxial with the central shaft (4), as shown in FIG. 2;

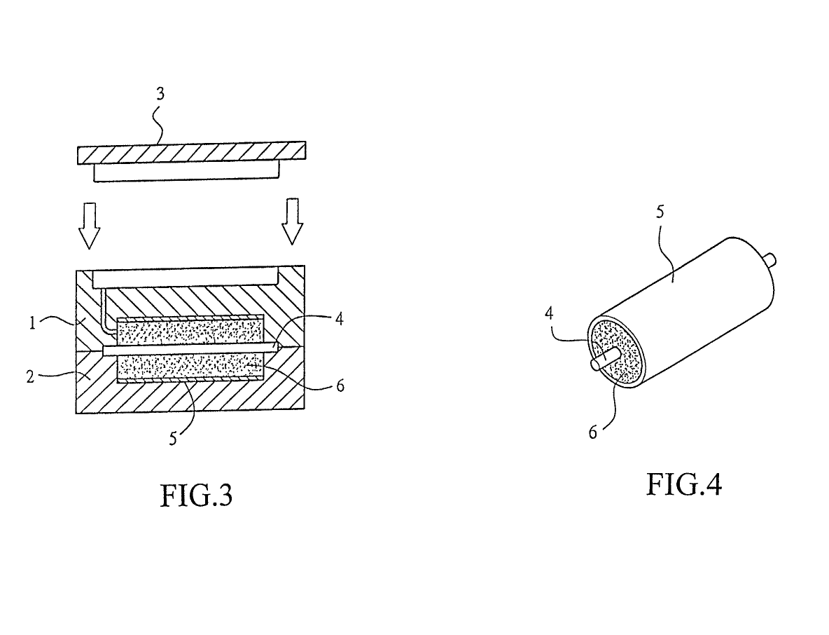

(c) the said pressing board (3) presses the rubber material in the material tough (13) of the upper die (1), via the pouring channel (14) and from the half-round die cavity (11) of the upper die (1), between the central shaft (4) and the seamless tube (5) to form a rubber roller (6) on the central shaft (4), as shown in FIG. 3;

(d) the rubber roller (6) is taken out with the seamless tube (5) after the dies are opened, as shown in FIG. 4;

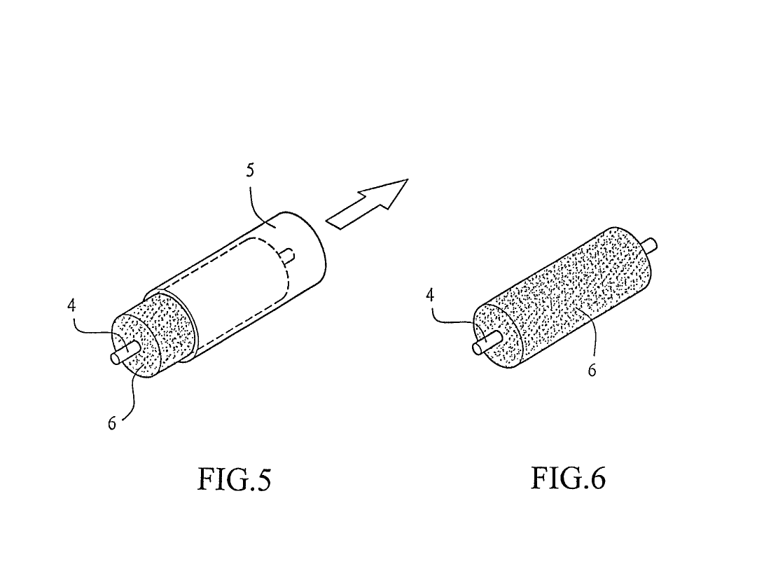

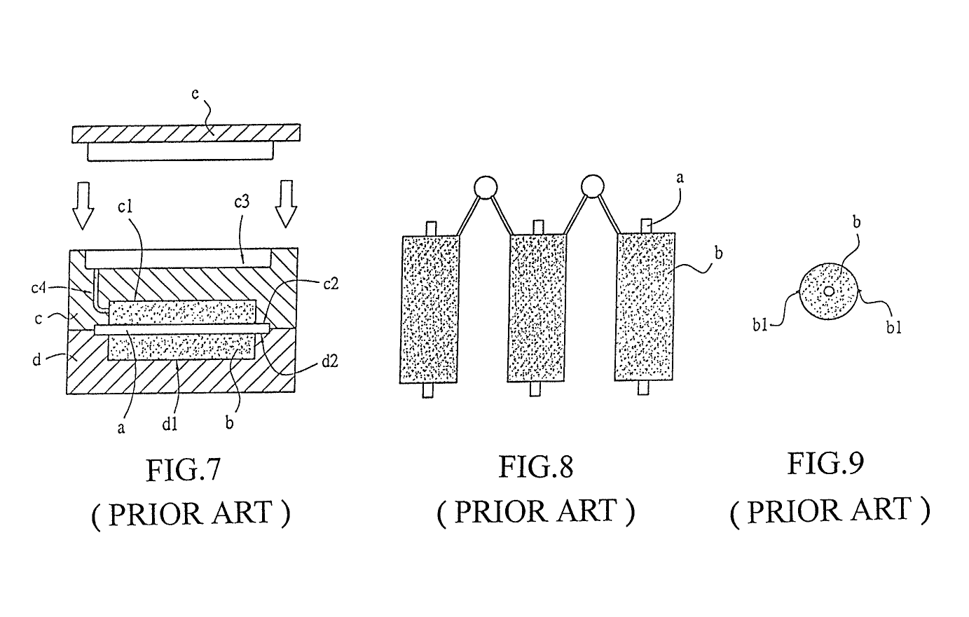

(e) after the said rubber roller (6) is cooled, the rubber roller (6) molded on the central shaft (4) is pulled out of the seamless tube (5), as shown in FIGS. 5 and 6.

According to the mentioned manufacturing method, since a seamless tube (5) is housed inside the half-tube die cavities (11, 21) of the upper die (1) and the lower die (2), the joint line between the upper die (1) and the lower die (2) is eliminated by using the seamless tube (5); therefore, after the rubber roller (6) is molded on the central shaft (4), the surface of the said rubber roller (6) does not has joint line thereby has a complete and smooth surface.

After the said rubber roller (6) is pulled out of the seamless tube (5), the manufacture of the said rubber roller (6) is accomplished and requires no more processing nor grinding, thereby the processing procedure is eliminated and the manufacture cost is reduced.

Since the said rubber roller (6) needs no more grinding or cutting, therefore, no predetermined processing allowance is required; it saves the material and reduces the material cost.

Furthermore, since there is no joint line on the surface of the said rubber roller (6), the situation of stress concentration caused by the joint line is eliminated; therefore, the shrinking condition to be happened later is also eliminated and a preferred real roundness is obtained.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A method of manufacturing a roller rod comprises:
(a) a pair of symmetric half-tube die cavities are disposed respectively between the upper die and the lower die; two half-round bearing holes are disposed respectively at the two ends of the half-tube die cavities; the top plane of the upper die is disposed with a material trough; a pressing board is housed in the upper aspect of the said material trough for pressing the rubber material out; the said pressing board is mounted in the lower aspect of a pressing machine; a pouring channel is disposed between the lateral sides of the material trough and the half-tube die cavity;
(b) a central shaft penetrates a seamless tube and bridges on two opposite half-round bearing holes of the upper die and the lower die to make the seamless tube house in the half-tube die cavities and coaxial with the central shaft;
(c) the said pressing board presses the rubber material in the material trough of the upper die, via the pouring channel and from the half-round die cavity of the upper die, between the central shaft and the seamless tube to form a rubber roller on the central shaft;
(d) the rubber roller is taken out with the seamless tube after the dies are opened;
(e) after the said rubber roller is cooled, the rubber roller molded on the central shaft is pulled out of the seamless tube.
